(19) United States
(12) Patent Application Publication
(10) Pub. No.: US 2006/0165955 A1
(43) Pub. Date: Jul. 27, 2006

(54) Structural Component Consisting of Fibre-Reinforced Thermoplastic

(75) Inventors: Andreas Ruegg, Zurich (CH); Stefan Ziegler, Zurich (CH)

Correspondence Address: OPPEDAHL AND LARSON LLP, P O BOX 5068, DILLON, CO, 80435-5068, US

(73) Assignee: RCC Regional Compact Car AG, Kusnacht (CH)

(21) Appl. No.: 10/527,953

(22) Filed: Mar. 14, 2005

(30) Foreign Application Priority Data
Sep. 15, 2002 (CH) 1567/02

(51) Int. Cl. B32B 5/12

(52) U.S. Cl. 428/113

(57) ABSTRACT

Abstract of the Disclosure

A structural component (1) is made out of long- fiber reinforced thermoplastic material (LFT) with integrated continuous fiber (CF) – reinforcement. It includes at least three individually integrated, shaped CF - profiles (10), which form a three-dimensional intersection point (50). In this, at least one CF - profile (10) lies in an upper plane (H1), at least one CF-profile lies in a lower plane (H2) of the intersection point and at least one CF - profile extends continuously in a vertical direction (v) between these CF - profiles of the upper and of the lower main plane. The CF - profiles (10) are connected to one another by shapings (32) of the LFT - mass (6) at the intersection point in a force-transmitting manner. At several points loads (L) are exerted on the CF - profiles. Such three-dimensionally applied loads (L) are capable of being optimally supported.

### Detailed Description of the Invention

### Background

The invention is related to a structural component made of long- fiber reinforced thermoplastic material with integrated continuous- fiber reinforcements.

Known structural components of this kind in most instances comprise plane continuous fiber reinforcements, e.g., with semi-finished fabric products or with a sandwich structure, which, however, are very limited with respect to possible shapings and applications. Structural components with integrated continuous fiber strands have also become known. International patent application publication WO99/52703 (see also U.S. Pat. No. 6821613) discloses a structural component with a shape forming long- fiber reinforced thermoplastic matrix and with an integrated load-bearing structure made of continuous fiber strands. In this, the continuous fiber strands are joined to one another by plane junction points. This, however, solely results in simple, plane load-bearing structures and not in three-dimensionally shaped continuous fiber reinforcement structures, and therefore does not provide the optimum absorption and transmission of three-dimensionally attacking loads and forces.

It would thus be very desirable if a way could be found to overcome the disadvantages and limitations of the known structural components and to create a structural component with a light continuous fiber reinforcement structure, and if this could make possible a three-dimensional support and transmission of loads and forces to be absorbed, with an optimum adaptation to the force gradients for a broad range of applications.

### Summary of the invention

This objective is achieved in accordance with the invention by a structural component with an integrated three-dimensional intersection point, which is formed out of several individual, shaped continuous fiber (CF) - profiles in a long- fiber thermoplastic (LFT) - mass.

The dependent claims relate to advantageous further developments of the invention with respect to optimum three-dimensional design of the continuous fiber reinforcement structure and utilisability in a large number of applications with optimum mechanical characteristics for the absorption of loads in any direction. This results in light, easy-to-manufacture structural components, e.g., for means of transportation, vehicles and vehicle components with load-bearing functions.

### Description of the drawing

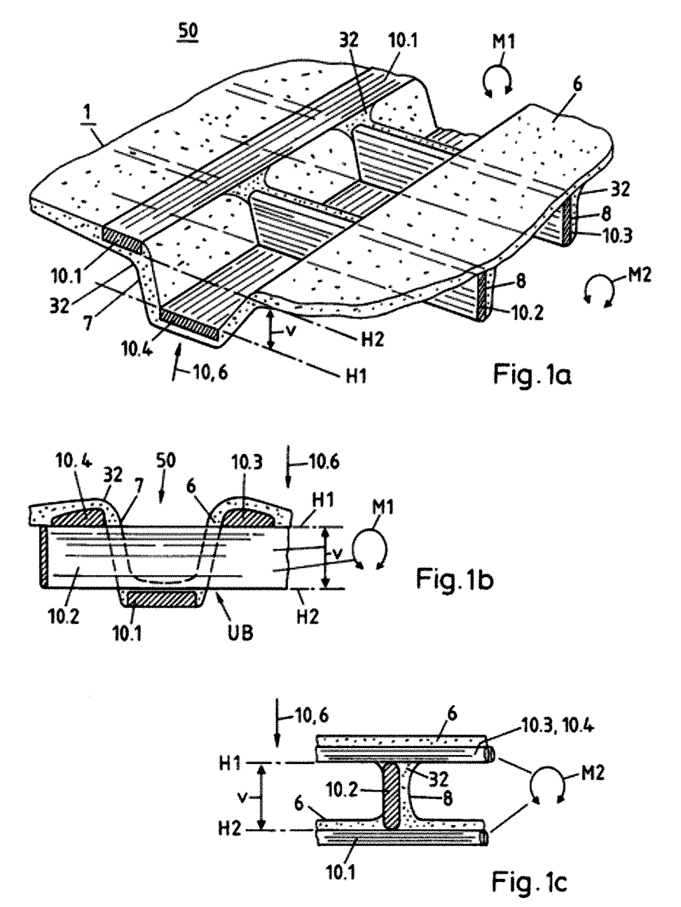

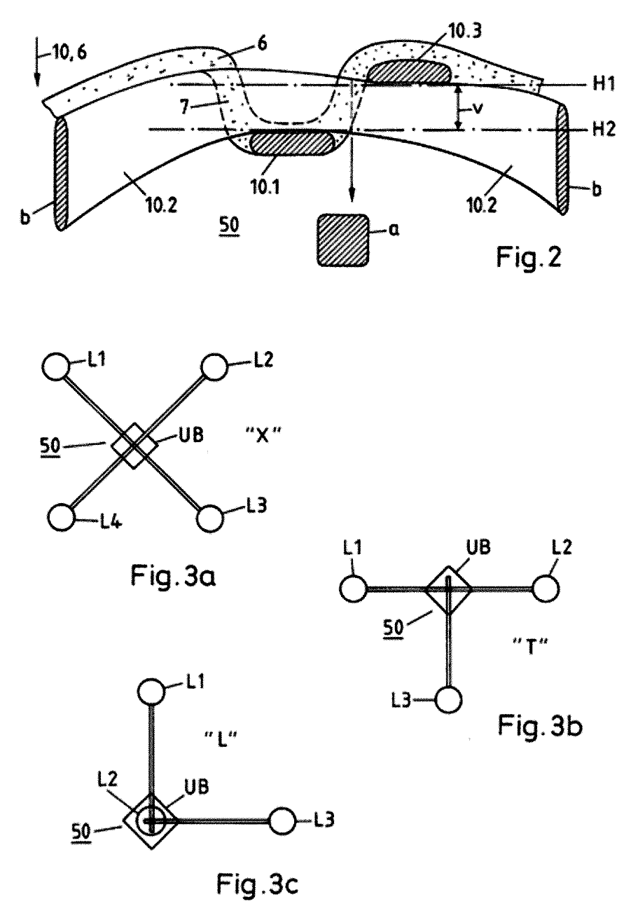

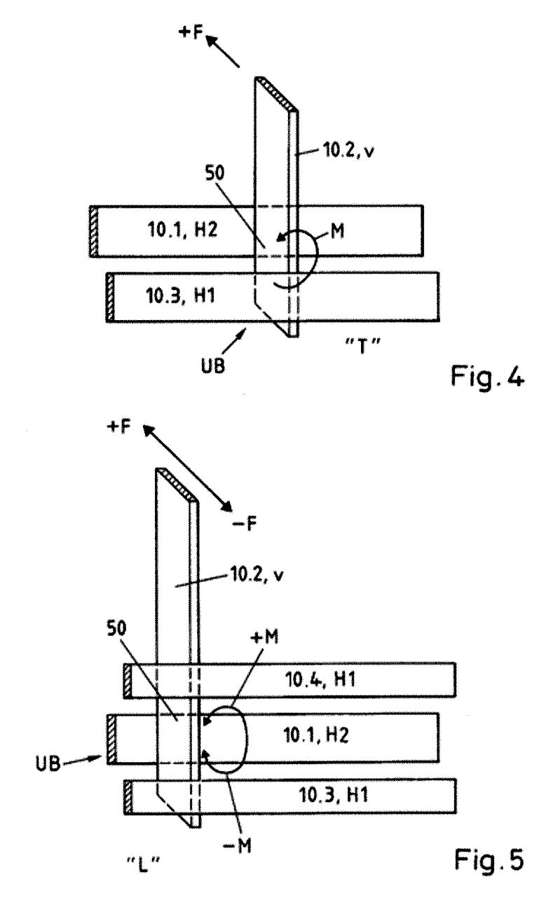

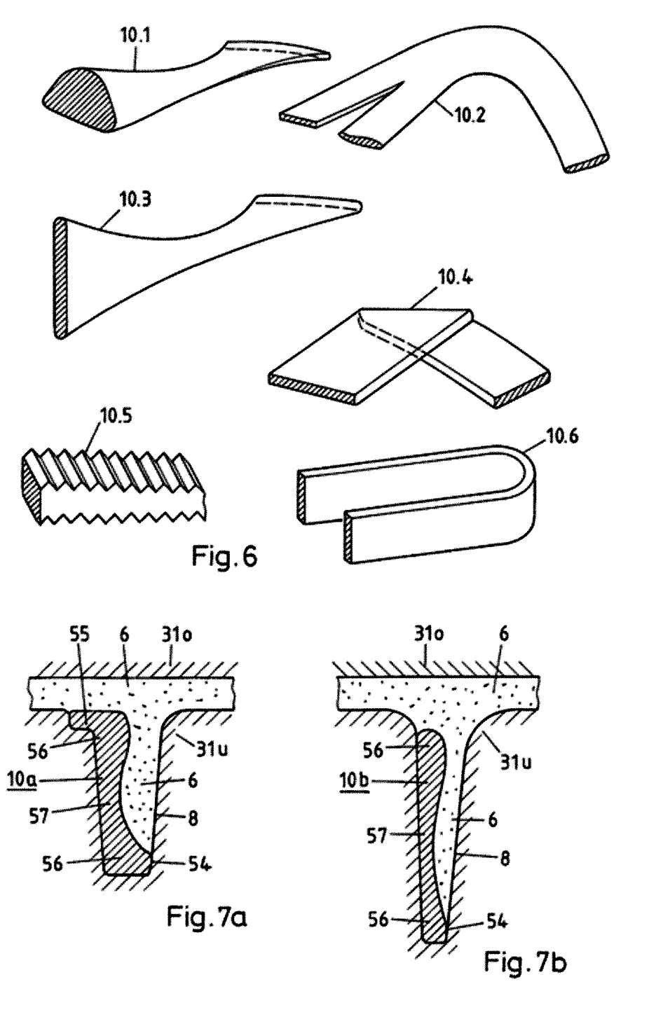

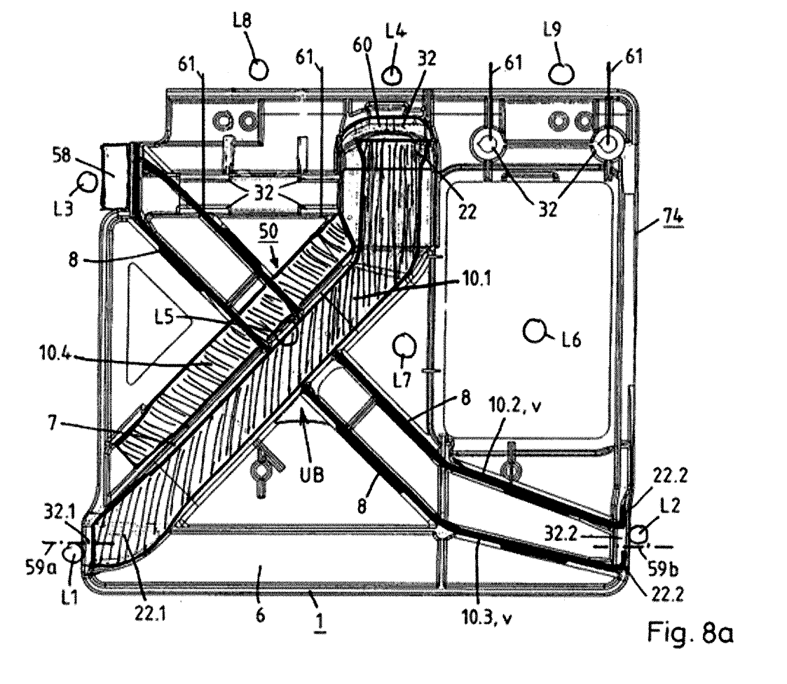

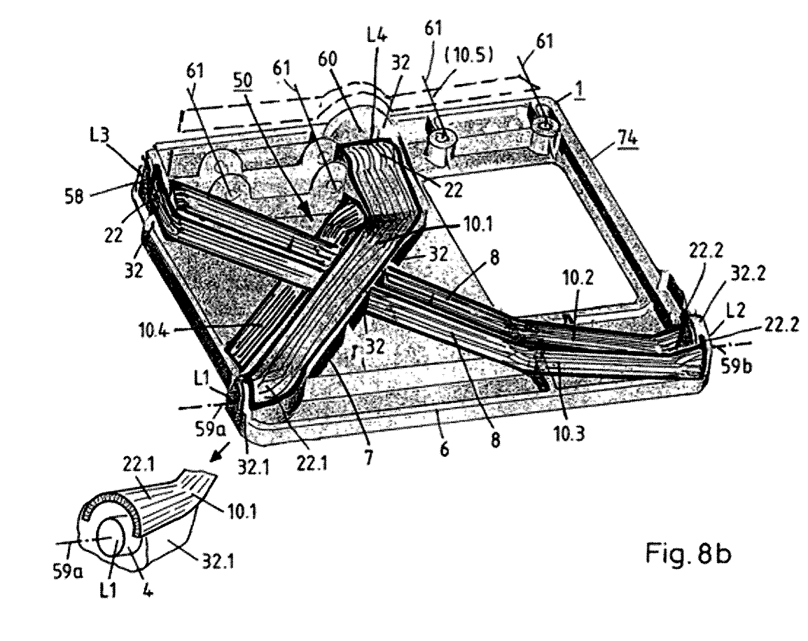

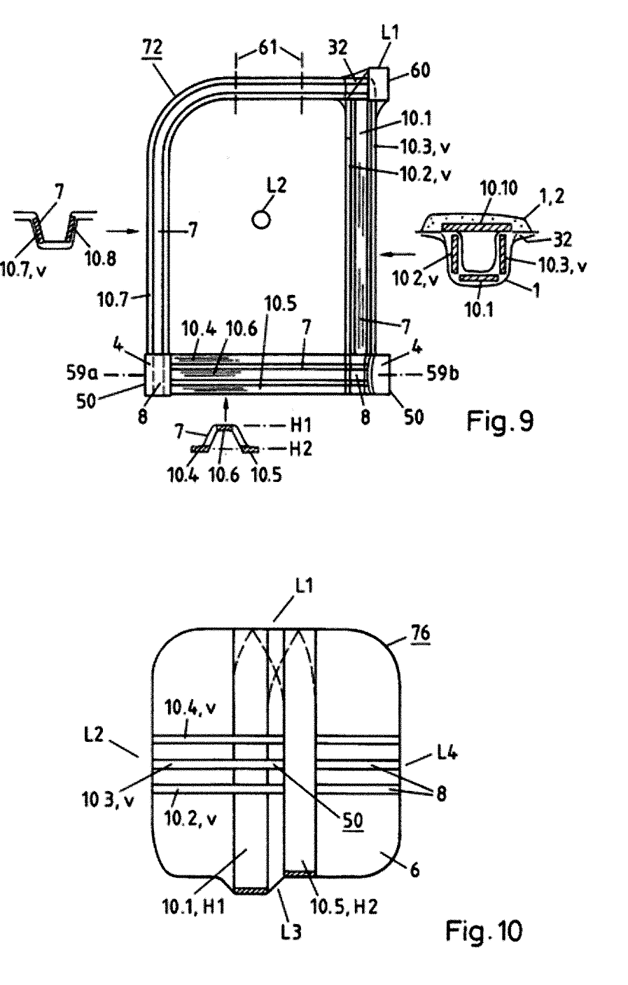

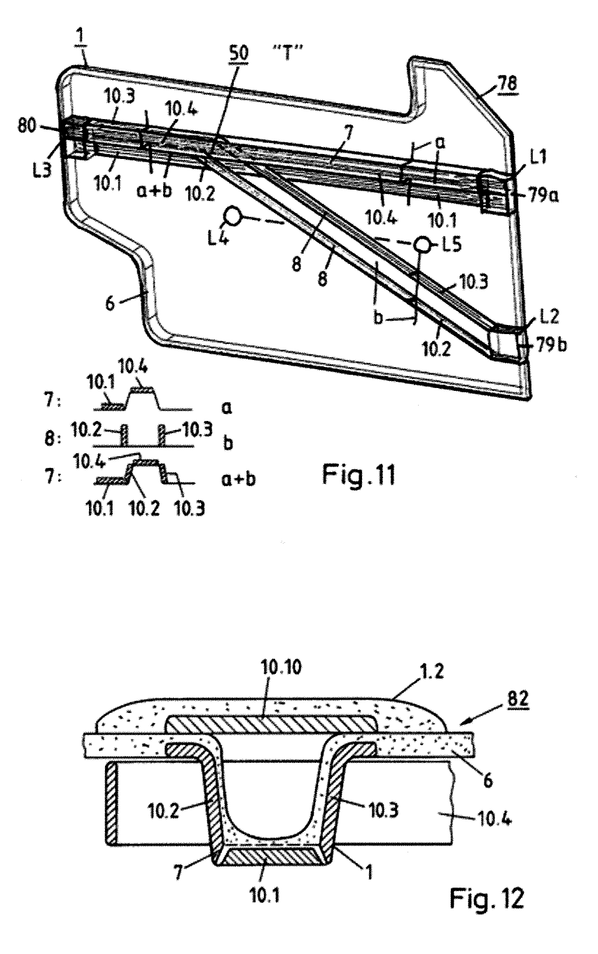

The invention will be described with respect to a drawing in several figures:
Fig. 1a - a structural component according to the invention with a three-dimensional intersection point of several CF - profiles,
Fig. 1b, c - cross-sections through a three-dimensional intersection point in different views,
Fig. 2 - a further example of a three-dimensional intersection point with variable profile cross-sections,
Fig. 3a - an "X" - shaped intersection point,
Fig. 3b - a "T" - shaped intersection point,
Fig. 3c - an "L" - shaped intersection point,
Fig. 4 - a "T" or "X" - shaped moment load-lever structure,
Fig. 5 - an "L" - shaped moment load-lever structure,
Fig. 6 - examples of three-dimensional profile shapings,
Fig. 7a, b - two different cross-sectional shapes of an CF - profile in a rib,
Fig. 8a - an arrangement of several CF - profiles in a 2/3 rear seat back with three-dimensional intersection point,
Fig. 8b - the LFT - shaping of the component with the integrated CF - profiles,
Fig. 9 - a single seat back with three-dimensional intersection points,
Fig. 10 - an arrangement of CF - profiles as seat shell or cabin floor,
Fig. 11 - a car door structure, and
Fig. 12 - an example of a two-shell component.
Where possible, like elements have been designated with like reference designations.

### Detailed description

Fig. 1a illustrates a portion of a structural component which, according to the invention, has a three-dimensionally developed (spatial) intersection point 50. The structural component comprises a shaping LFT - mass 6 (made of long- fiber reinforced thermoplastic) with a continuous fiber reinforcement comprising several individual, integrated CF - profiles 10. As will be discussed in more detail below, the CF profiles each have a defined shaping, and each is shaped corresponding to the forces and loads to be absorbed; each is individually precisely positioned within the structural component.

The three-dimensional intersection point 50 comprises an upper main plane H1 and a lower main plane H2, the two planes defining a vertical spacing v. The intersection point 50 is formed by (a) at least three CF - profiles, which run together, by which is meant that they intersect with one another at the intersection point, and (b) by the LFT - mass 6 joining all these profiles. In this, at least one CF - profile has to lie in the upper main plane H1 (here the profile 10.1) and one CF - profile in the lower main plane H2 (here the profile 10.4). And between the CF - profiles of the upper and of the lower main plane at least one further CF - profile, here the profiles 10.2 and 10.3, with a vertical orientation (by which is meant that they have an extension in vertical direction), has to pass through, in order to absorb a moment M2. All CF - profiles are joined together at the intersection point by the LFT – mass 6 in a force transmitting manner through corresponding shapings 32 of the LFT - mass, that is to say, through suitable selections of the shapes of the CF - profiles and of the LFT - mass.

In the example of Fig. 1a the CF - profiles 10.1, 10.4 are located in a crimp 7 and the CF - profiles 10.2 and 10.3 in ribs 8. In this manner forces F, moments M and loads L, which act on a structural component in differing directions, are absorbed by the CF - profiles and transmitted to the three-dimensional intersection point 50. It is in particular possible to transmit moments at the intersection point from one profile pair to the other one. Here the CF - profiles 10.1 and 10.4 with the crimp 7 form a girder subject to bending and the profile pairs 10.2 and 10.3 in the rib structure 8 form a second girder subject to bending. Advantageously, for example the moments M1 and M2 are each able to be absorbed and each is able respectively to be transmitted elsewhere within the component. An essential advantage of this arrangement of the CF - profiles according to the invention at the three-dimensional intersection point is the fact that the intersection point consists of a single component and does not have to be assembled out of several components. As an example, this component may be manufactured by inserting the CF - profiles into an LFT - shaping tool (one after the other or together) and subsequently a molten LFT - mass is introduced in a single step, and the constituents are pressed in an LFT - press to become a one-part structural component.

A typical sequence of manufacture will now be described. First the CF - profile 10.1 is deposited in the lower main plane H2, then the CF - profiles 10.2 and 10.3 are deposited in the vertical intermediate zone v and thereupon the CF - profile 10.4 is deposited in the upper main plane H1. Subsequently the molten LFT - mass 6 is placed on top and pressed together with the CF - profiles. It will be appreciated that for clarity of visual presentation, this Fig. 1a illustrates the component after it has been turned over, so that in the figure H1 lies at the bottom and H2 lies on top, and in this way the CF - profiles are well visible. The direction in which the CF - profiles 10 and the LFT - mass 6 are deposited, is indicated with an arrow 10,6.

Figs. 1b and 1c illustrate two sections through a second embodiment of a three-dimensional intersection point 50. In this second embodiment, there are two CF - profiles 10.3, 10.4 in the upper main plane H1, there is a CF - profile 10.1 in the lower main plane H2, and there is a CF - profile 10.2 in a rib 8 in the vertical zone v in between. The CF - profiles 10.1, 10.3, 10.4 lie in a crimp 7, which intersects with the rib 8. The position of the component here is illustrated in the manner it lies in the assembly tool (the LFT – tool).

Fig. 1b illustrates the cross-section through the crimp 7, (which absorbs the moment M1) and Fig. 1c illustrates the cross-section through the rib 8, (which absorbs the moment M2).

For the optimum force transmission of CF - profiles 10 on to the LFT - mass 6 and from an CF - profile (10.1) through the LFT - mass on to other CF - profiles (10.3, 10.4), the LFT - mass comprises bonding shapings 32. By the arrangement of the CF - profiles and the shapings 32 of the LFT - mass the required force transmission is produced at the three-dimensional intersection point 50.

Fig. 2 illustrates a third embodiment of a three-dimensional intersection point in a component, which is designed as a bent shell. The main planes H1 and H2 here form tangential planes at the intersection point 50. The vertical spacing between H1 and H2 is, in this embodiment, relatively small for reasons of limited space. In this embodiment the CF - profile 10.2 (which intersects with the flat CF - profiles 10.1 and 10.3 in the zone v at the intersection point) is able to comprise a reduced height with, e.g., a square cross-section a. Despite having a reduced height v at the area of cross-section a, the CF – profile 10.2 in its extent leftward and rightward in Fig. 2 is able once again to change over into a flat, vertically oriented cross-section b.

As a general matter, it is important to appreciate that the CF - profiles in the v - zone comprise a vertical extension for the purpose of transmission of moments. Stated differently, the CF - profiles 10 in principle are able to comprise any three-dimensional shaping and position, selected to adapt to particular load conditions and force gradients.

Figs. 3a, b, c schematically illustrate various possible types of three-dimensional intersection points. Each structural component has to absorb and to transmit onwards several loads L, forces F and moments M, which attack at different points of the structural component and in differing directions. The three-dimensional intersection points 50 according to the invention are able to be, for example, designed as "X"-, "T"- or "L"-shaped, by means of corresponding arrangements of the CF - profiles. Thus, for example:
Fig. 3a in this context illustrates an "X"-shaped intersection point with load absorptions at the points L1 to L4 and with force transmissions (designated “UB”) at the intersection point 50.
Fig. 3b illustrates a "T"-shaped intersection point with load absorptions at the points L1, L2, and L3 and with force transmissions at the intersection point.
Fig. 3c illustrates an "L"-shaped intersection point with the load absorptions L1, L2, L3 and at the point L2 also with force transmissions at the intersection point.

Figs. 4 and 5 illustrate examples of moment - load lever structures, which are formed by the arrangement of the CF - profiles with the intersection point 50.

Fig. 4 illustrates a moment - load lever structure with a "T"- or "X"-shaped intersection point 50. With it a force +F is supported as a main load direction, and the load is absorbed by a CF - profile 10.2 as vertically oriented profile v, e.g., in a rib between two horizontal CF - profiles 10.1 in the lower main plane H2 and 10.3 in the upper main plane H1. The force F results in a moment M, which is supported by the CF - profiles 10.1, 10.3 in an appropriate shaping of the LFT - tool, e.g., in a crimp.

Fig. 5 illustrates an "L"-shaped moment - load lever structure, which as a main load direction supports forces +F, -F (i.e., in both directions). It once again contains a vertically oriented profile 10.2 in the zone v, which is supported by three CF - profiles, e.g., at a crimp and in the main planes: the CF - profile 10.1 in H2 and the CF - profiles 10.3 and 10.4 in H1. With this, the moments +M, -M resulting from the forces +F, -F are supported and transmitted onwards.

It will thus be appreciated that the shaping and arrangement of the CF - profiles may be selected to deal with the differing functions and requirements at different points of a CF - profile. They may comprise a three-dimensional shaping and for this purpose in longitudinal direction comprise a bend, a rotation, a twisting, a folding and/or a surface structuring and they may comprise varying, differing cross-sectional shapes.

Fig. 6 illustrates examples of possible shapings of CF - profiles:
The CF - profile 10.1 manifests a roundish cross-section, which is flattened and spread out and in the spread-out area forms a large bonding surface to the surrounding LFT - mass (in the same manner as CF - profile 10.5 in this figure).
The CF - profile 10.2 comprises a flat arc and is split in two at one end.
The CF - profile 10.3 comprises a twist from a flat to a vertically oriented cross-section.
The CF - profile 10.4 manifests a fold.
The CF - profile 10.5 shows a surface that is structured and zig-zag-shaped, and in this way provides a greater surface area.
The CF - profile 10.6 is bent into a "U"-shaped double rib. This could be utilised, e.g., in place of the two CF - profiles 10.2 and 10.3 in Fig. 1a.

The Figures 7a, 7b illustrate an example of a CF - profile 10, which over its length comprises differing cross-sectional shapes, the differing cross-sectional shapes being in adaptation to the forces to be transmitted and for the optimum bonding with the LFT - mass 6. The Figures in cross-sectional view illustrate a CF - profile 10a, 10b in a rib 8, e.g., corresponding to the profiles 10.2 or 10.3 of Fig. 8, at two different locations.

Fig. 7a illustrates a shaping 10a with a positioning shoulder 55 for fixing and holding the CF - profile in the required position. The shoulder 55 is especially helpful during pressing, when the liquid LFT – mass 6 is pressed into the rib. On top and underneath the CF - profile respectively comprises a thicker zone 56 as tensile - and compressive zones (in longitudinal fiber direction) for the transmission of moments. Located in between is a thinner thrust zone 57 with a correspondingly thicker adjacent LFT - layer 6 and with a large bonding surface area and a particularly strong interface joint. With this, the shear resistance is increased by the adjacent LFT - layer 6 with isotropic fiber distribution (while the strength transverse to the fiber orientation in the CF - profiles 10 here is lower).

The rib shown in Fig. 7a as just discussed, is shown again at another location in Fig. 7b. At this part of the rib, the profile cross-section 10b is selected corresponding to a force situation there: stretched, i.e., higher and narrower and without a positioning shoulder.

It is desirable that during manufacture, the CF-profiles be securely and accurately positioned and fixed. Thus during the pressing with the LFT - mass, further positioning points 54 may be developed on the CF - profiles, which correspond to the shaping of the LFT - tool 31o (top, “o” standing for “over”) and 31u (bottom, “u” standing for “under”). Here the positioning point 54 serves for the accurate positioning below in the rib 8. Positioning points can also be arranged suitably distributed in the longitudinal direction of the CF - profiles.

In an analogous manner, profile shapes of this kind may also be positioned and fixed on crimped walls, e.g. on the two side walls of a crimp 7 instead of the two CF - profiles (10.2., 10.3) in two separate ribs 8, as it is illustrated in the following example of Fig. 8.

Designs other than those shown in Figs. 7a, 7b may be devised. For example it is possible to design the cross-sections of CF – profiles as “L”- or “Z”-shaped, depending on the application.

Figs. 8a, b illustrate a complex structural component with a three-dimensional intersection point in the form of a two third (2/3) rear seat back 74 with a central seat belt connection 60 for the middle seat and a lock 58 and with several demanding load introductions for different load cases (crash loads). Fig. 8a in plan projection illustrates the arrangement of the CF - profiles in the component. Fig. 8b is a perspective view the LFT - mass 6 and shown within it the integrated CF - profiles 10.1 to 10.4. This example illustrates the load-optimised shaping of the CF - profiles themselves as well as the load-optimised arrangement of the CF-profiles to form a structure with a corresponding shaping of the LFT - mass 6 and with an optimum bonding strength between the CF - profiles carrying the main loads (with directed continuous fibers) and the complementing LFT - mass (with undirected long fibers).

Here four main load carrying points L1 to L4 result from:
the loads L1, L2 on the axle holders 59a, 59b, around which the rear seat back 74 is capable of being swivelled,
the load L3 on the lock 58, for fixing the rear seat back in its normal position and
the load L4 on the belt lock, namely a belt roller 60 for the central belt of the middle seat.

With this structural component the following loads (with the further loads L5 to L9) are provided for:
front - and rear collision,
securing of any goods loaded,
belt anchoring, and
head support / head rest anchoring.

For the receiving and transferring of all loads and forces the intersecting CF - profiles together with the joining force-transmitting shapings of the LFT - mass form a spatial, three-dimensional intersection structure 50. Here the CF - profiles respectively in pairs in the LFT – shapings form a moment-transmitting girder subject to bending:
the CF - profiles 10.1 and 10.4 in a crimp 7 of the LFT – mass form a girder subject to bending between the loads L1 and L4
the CF - profiles 10.2 and 10.3 in the ribs 8 of the LFT - mass form a girder subject to bending between the loads L2 and L3.

Through the three-dimensional intersection point 50, in this the load L4 on the belt roller 60 and also other loads, which act on the girder subject to bending 10.1 / 10.4, is also supported on the other girder subject to bending 10.2/ 10.3 (and vice-versa).

The main forces, namely loads L1 to L4, are received by means of force introduction points:
through shapings 22 and 32 of the CF - profile ends and of the LFT - mass for receiving the external forces with or without inserts 4;
in doing so, the inserts 4 prior to the pressing operation are able to be inserted into the LFT - tool and then pressed together with the CF - profiles and the LFT mass;
or else it is also possible to fit them into the component later on.

Here the CF - profile 10.1 comprises an arc-shaped widening 22 and an adapted widening 32.1 for receiving a metallic insert 4 at the axle bearing 59a. The other axle holder receptacle 59b is formed by shapings 22.2 of the CF - profiles 10.2 and 10.3 and by adapted joining shapings 32.2 of the LFT - mass. These profile ends 22.2 are bent over and in this manner anchored in the LFT - mass for the purpose of increasing the tensile strength. The lock 58 is bolted on to a lock plate on the CF - profile 10.3 and supported by the CF - profile 10.2. The belt roller 60 is supported by shapings 22 of the CF - profiles 10.1 and 10.4 and by LFT - shapings 32.

The smaller loads L8, L9 of head supports 61 here are absorbed through LFT - shapings 32. For reinforcement, however, it would also be possible to integrate an additional CF - profile 10.5 deposited transversely (in some zones oriented flat or vertically).

In the case of this component just discussed, the manufacturing steps include the following:

a depositing sequence of the CF - profiles into the LFT - tool is as follows:
first the CF - profile 10.1 is deposited into the LFT-tool (in H2);
thereafter the CF - profiles 10.2 and 10.3 are deposited into the LFT-tool;
subsequently the CF - profile 10.4 is deposited into the LFT-tool (in H1).

Then the liquid LFT - mass 6 is introduced and the complete tool is pressed as a single shell and as a single part in a single step.

In Figs. 8a and 8b, the illustrated structural component is lying in the LFT - shaping tool upside down, i.e., in the figure H2 is at the bottom and H1 is on top. Stated differently, Fig. 8 illustrates the rear side of the rear seat back 74.

In this example also the three-dimensional profile shaping is evident in many variants.

The shapings in the structural component may comprise special shapings 22 for force transmissions and for the direct absorption of external loads, particularly, for the receiving of inserts 4 (mounting parts), at which external loads are introduced into the component. The shaping of the surrounding LFT - mass 6 is also selected to match the shaping of the CF - profiles 10. Shapings of force transfer points (of forces and moments) inside a component (e.g., from an CF - profile through the LFT - mass on to other CF - profiles) can be formed both as shapings 22 of the CF - profiles as well as shapings 32 of the LFT- mass.

To the extent possible, rather than employing abrupt steps in the interface between the CF-profiles and the LFT-mass, continuous and smooth transitions are employed.

Fig. 9 illustrates a single seat back 72 with a belt connection 60 and head supports 61, in the case of which similar loads and load cases occur as in the example of Fig. 8, here with the main loads being load L1 at the belt connection 60, and load L2 due to the weight of the passenger. All loads, however, have to be supported by the axle holders, which are capable of being fixed at 59b, and possibly also at 59a, around which the seat back is capable of being swivelled. In this, the swivel locking may be present on both sides (at both 59b and 59a) or frequently only on one side at 59b. In the latter case, a profile support formed out of CF - profiles between the lock 59b and the belt connection 60 has to be designed to be particularly strong with an enhanced stiffness against torsion. For this purpose here a closed hollow profile cross-section can be formed (in analogy to Fig. 12), for example, with three CF - profiles 10.1, 10.2, 10.3 in a crimp 7 of the structural component 1 and thereupon a separate cover component 1.2 with an CF - profile 10.10 may be thermoplastically welded.

The profile support between the axle holders and the locks 59a and 59b here comprises the CF - profiles 10.4, 10.5, 10.6 in the main planes H1, H2 on a crimp 7. The profile support between the axle holder 59a and the belt connection (belt roller) 60 is curved and comprises two vertical CF - profiles 10.7, 10.8, e.g., in the side walls of a crimp 7. Here two three-dimensional intersection points 50 are formed on the axle holders 59a and 59b. In doing so, all CF - profiles are integrated into crimps here, wherein at the three-dimensional intersection points of the CF - profiles the crimps locally become ribs, so that there an intersection point between a rib 8 and a crimp 7 is always produced and so that all CF - profiles are capable of being deposited in a single step and the structural component 1 is able to be pressed in a single step and in a single piece. It goes without saying, that other arrangements of CF - profiles in ribs and in crimps are also able to be combined as per requirements.

Fig. 10 illustrates an arrangement of CF - profiles with a three-dimensional intersection point 50, which is designed as a seat shell 76 or as a cabin floor, e.g., of a lift cabin. In order here to implement a shell with a relatively small thickness, i.e., with a small vertical spacing v between the main planes H1, H2, in this case three vertical CF - profiles 10.2, 10.3, 10.4, are integrated into a rib structure, which intersect with two CF - profiles 10.1, 10.5 in the main planes H1, H2. At a free end L1 of a seat shell, the CF - profiles 10.1 und 10.5 may also run together and may be directly joined together there in a plane manner. This structure supports the loads L2 – L4 ( and also the load L1).

Fig. 11 illustrates an example of a structural component, which forms a supporting structure of a car door 78 with integrated side crash protection. The CF - profile structure with a "T"-shaped intersection point 50 is formed by two girders with CF - profiles subject to bending running together at the intersection point, which, connect the force absorbing load points L1 and L2 (namely upper and lower door hinge 79a and 79b) as well as L3 (namely door lock 80). The girder a connects the upper hinge 79a with the lock 80 and the girder b connects the lower hinge 79b with the lock 80, wherein this latter girder b merges into the girder a at the intersection point 50 and continues on up to the lock 80 (thus defining a more complex structure shown as a + b). Cross-sectional views show:
the arrangements of the CF - profiles 10.1, 10.4 of the girder a in a crimp 7;
the arrangements of the CF - profiles 10.2, 10.3 of the girder b in the ribs 8; and
the combination a + b with all four CF - profiles on the crimp 7.

This results in a strong and lightweight reinforcing structure, thus for example being capable of absorbing and supporting side crash loads L4, L5.

Fig. 12 illustrates an example of a structural component 82, which is assembled out of several parts, e.g., out of two shells, e.g., by welding or by gluing. Here a structural component 1 with an intersection point is joined to a further component 1.2, which forms a cover to an open crimp, so that both components 1 and 1.2 together form a closed, tubular, CF - reinforced profile cross-section with particularly high stiffness against torsion (as was explained above as a variant in Fig. 9). Two-part components of this kind are preferably welded together thermo-plastically. The shaping of the vertically oriented CF - profiles 10.2 and 10.3 in the side walls of the crimp 7 may, e.g., also comprise a flat part, which is adapted to the CF - profile 10.10 in the cover component 1.2. Behind these CF - profiles 10.2, 10.3 it would be possible for example to form a three-dimensional intersection point 50 with a vertical CF - profile 10.4 running through transversely.

It is instructive to discuss materials that are suitable for the structural components according to the invention

Fiber lengths. The LFT - mass 6 advantageously comprises an average fiber length of at least 3 mm, or more preferably in the range of of 5 – 15 mm. The continuous fiber (CF) reinforcement of the CF - profiles may consist of directed glass -, carbon - or aramide fibers in the thermoplastic matrix. Where the highest compressive strengths are needed, boron fibers or steel fibers may be employed.

Orientation and distribution of fibers. The CF - profiles 10 are capable of being mainly built-up out of UD (unidirectional) - layers (0°). It is also possible, however, to build up the CF-profiles from layers with differing fiber orientations, e.g., alternating with layers of 0°/90° or 0°/+45°/-45° fiber orientations. They could possibly also comprise a thin surface layer (e.g., 0.1 – 0.2 mm) made of pure thermoplastic material without any CF - fiber reinforcements.

Selection of polymers. For structural components as discussed herein, partially crystalline polymers such as polypropylene (PP), polyethylene-therephthalate (PET), polybutylene-therephthalate (PBT) or polyamide (PA) are well suited for the matrix of CF - profiles 10 and for the LFT - mass 6. One reason these polymers work well is that they are capable of comprising higher compressive strengths. It is also possible, however, to utilise amorphous polymers such as ABS (acrylonitrile butadiene styrene) or PC (polycarbonate).

Within the scope of this description, the following designations are used:
1 - Structural component
1.2 - Second part (two-shell)
4 - Inserts, inlays
6 - LFT - mass, form mass
7 - Crimp
8 - Rib
10 - CF - profiles
22 - CF - profile shapings
32 - LFT - shapings
50 - Three-dimensional intersection point
54 - Positioning points
55 - Positioning shoulder
56 - Thick tensile - and compressive force zones in 10
57 - Thinner thrust zone
58 - Lock
59a, b - Axle holders
60 - Belt roller, belt connection, belt lock
61 - Head supports
72 - Single seat
74 - 2/3 Rear seat back
76 - Seat shell, cabin floor
78 - Car door
79 - Door hinges
80 - Door lock
82 - Two-shell structural component
LFT - Long- fiber thermoplastic
CF - Continuous fiber
H1 - Upper main plane of 50
H2 - Lower main plane of 50
v - Distance between H1 and H2 (vertical)
L - Loads (K, M)
F - Forces
M - Moments
UB - Force transmission at 50
"T"-, "L"-, "X"-shaped intersection point

Those skilled in the art will have no difficulty at all in devising myriad obvious improvements and variations upon the invention, all of which are intended to be encompassed within the claims that follow.

What is Claimed is:

1. A structural component made of long- fiber reinforced thermoplastic material with integrated continuous fiber - reinforcements, the component comprising:
- at least three individually integrated, shaped continuous fiber profiles,
- the at least three continuous-fiber profiles running together at a location,
- the at least three continuous-fiber profiles, at the location where they run together, defining a three-dimensionally developed intersection point,
- wherein at the intersection point at least a first continuous-fiber - profile lies in an upper plane of the intersection point, at least a second continuous-fiber profile lies a lower plane of the intersection point, and wherein at least a third continuous-fiber- profile with a vertical extension extends continuously between the first and second continuous-fiber – profiles;
- wherein the continuous-fiber - profiles are joined together by the long-fiber-reinforced thermoplastic material at the intersection point.

2. The structural component of claim 1, characterised inthat points of introduction of external force are formed by means of shapings of the long-fiber-reinforced thermoplastic, or by shapings of continuous-fiber profiles, or both.

3. The structural component of claim 1, characterised inthat the three-dimensional intersection points are developed as "X"-, "T"- or "L"-shaped.

4. The structural component of claim 1, characterised inthat the continuous-fiber - profiles are arranged in such a manner at the intersection point, that the continuous-fiber - profiles are capable of being inserted into a shaping tool for long-fiber-reinforced thermoplastic one after the other or together, and subsequently are capable of being pressed together with an introduced, molten long-fiber-reinforced thermoplastic - mass (6) in a press for long-fiber-reinforced thermoplastic in a single step and into a one-piece component.

5. The structural component of claim 1, characterised inthat the continuous-fiber- profiles are built up out of layers with differing fiber orientations.

6. The structural component of claim 1, characterised inthat the long-fiber-reinforced thermoplastic mass comprises an average fiber length of at least 3 mm.

7. The structural component of claim 1, characterised inthat the continuous-fiber - profiles comprise a continuous fiber reinforcement made out of glass -, carbon - or aramide fibers.

8. The structural component of claim 1, characterised inthat the thermoplastic material of the long-fiber-reinforced thermoplastic mass 6) and of the continuous-fiber - profiles consists of partially crystalline polymers selected from the set consisting of polypropylene, polyethylene-therephthalate, polybutylene-therephthalate and polyamide.

9. The structural component of claim 1, characterised inthat the continuous-fiber profiles comprise a three-dimensional profile shaping.

10. The structural component of claim 1, characterised inthat the continuous-fiber - profiles comprise a bend, a twist, a fold or a surface structuring in longitudinal direction.

11. The structural component of claim 1, characterised inthat the continuous-fiber- profiles comprise differing cross-sectional shapes.

12. The structural component of claim 1, characterised inthat shapings on the continuous-fiber - profiles and shapings of the long-fiber-reinforced thermoplastic mass are provided for force introductions and for force transmissions between the continuous-fiber- profiles and the long-fiber-reinforced thermoplastic - mass as well as to inserts.

13. The structural component of claim 1, characterised inthat a continuous-fiber - profile with a positioning shoulder, a thick tensile - and compressive force zone on top and underneath as well as a thinner thrust zone in between is formed, which is positioned in a rib or in a crimp wall of the structural component.

14. The structural component of claim 1, characterised inthat the continuous-fiber - profiles form a moment - load lever structure with a T-shaped or L-shaped three-dimensional intersection point.

15. The structural component of claim 1, characterised inthat the structural component forms a single seat back with a belt connection.

16. The structural component of claim 1, characterised inthat the structural component forms a two-thirds rear seat back with belt connection and lock.

17. The structural component of claim 1, characterised inthat the structural component forms a seat shell or a cabin floor.

18. The structural component of claim 1, characterised inthat the structural component forms a supporting structure of a car door with integrated side-crash protection.

19. The structural component of claim 1, characterised inthat the structural component is assembled out of at least two parts welded together.

20. A method for the manufacturing of a structural component, the method comprising the steps of:
depositing several shaped continuous-fiber- profiles in a tool for shaping long-fiber-reinforced thermoplastic, n LFT - shaping tool,
the profiles deposited one after another or together;
subsequently introducing a long-fiber-reinforced thermoplastic mass;
in a single step, pressing the long-fiber-reinforced thermoplastic mass together with the continuous-fiber - profiles into a one-piece component.
